(19) United States
(12) Patent Application Publication
(10) Pub. No.: US 2012/0280934 A1
(43) Pub. Date: Nov. 8, 2012

(54) Simulating Single and Multi-Touch Events for Testing A Touch Panel

(75) Inventors: Tho T. Ha, San Jose, CA (US); Razieh Ghaffari, Cupertino, CA (US)

(73) Assignee: Apple Inc., Cupertino, CA (US)

(21) Appl. No.: 13/100,777

(22) Filed: May 4, 2011

(51) Int. Cl. G06F 3/041

(52) U.S. Cl. 345/174; 901/14

(57) ABSTRACT

An apparatus for testing a touch panel is disclosed. The apparatus includes a robot hand that is to be positioned over a touch panel under test. The robot hand moves toward and away from the touch panel. A first testing finger and a second testing finger are coupled to the robot hand. As the robot hand moves toward the touch panel, the first testing finger is to contact the touch panel to simulate a one finger touch, and the second testing finger is to subsequently contact the touch panel to simulate a two finger touch. Other embodiments are also described and claimed.

An embodiment of the invention relates to testing a touch panel. Other embodiments are also described.

### BACKGROUND

Many electronic devices use touch screen displays that detect user gestures on the touch screen and translate detected gestures into commands to be performed. As the use of devices with touch screens continue to increase, the types and configurations of touch screens have also continued to expand. Device manufacturers now incorporate touch screens and associated software that accurately track multiple fingers touching at the same time, also referred to as multi-touch interfaces. Multi-touch screens are prevalent in handheld multi-function mobile devices such as smart phones and tablet computers, but they may also be used in other devices such as navigation systems, automated teller machines, and point-of-sale terminals.

Because reliable operation is an important factor for satisfactory performance of a touch screen, there arises a corresponding need to test the touch screen thoroughly. Although such tests can be done manually where a human technician for example places her two fingers simultaneously on the touch screen while a test program is running in the device, testing of this nature can be time consuming and thus expensive. Moreover, manual testing presents the possibility that the person conducting the test may not accurately follow the test routine, resulting in touch screens that are not fully tested. Also, where the durability of a touch screen is to be tested by, for example, repeated actuation of a virtual button, manual testing is impractical because of the length of time required to complete such tests.

### SUMMARY

An embodiment of the invention is an apparatus for automated testing of a touch panel. The apparatus includes a robot hand and at least two testing fingers of different lengths. The two testing fingers are coupled to the robot hand. The robot hand and the two testing fingers are positioned such that the two testing fingers point toward the touch panel under test. When the robot hand then moves toward the touch panel, the longer testing finger contacts the panel first, to simulate a single-touch event. As the robot hand then continues to move in the same direction toward the touch panel, the longer testing finger contracts until the shorter testing finger also contacts the panel. At that point, a two-touch event is being simulated.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Embodiments of the invention will now be described with reference to the drawings summarized below. The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a perspective view of a touch screen testing system.

FIG. 2 is a block diagram of some of the hardware functional units and hardware components that are particularly relevant for testing a touch screen.

FIG. 3 is an elevation view of a part of a robot hand in the touch screen testing system of FIG. 1.

FIGS. 4-6 are a sequence of figures showing the movement of the robot hand of FIG. 3.

FIG. 7 is a flow chart showing the operation of the robot hand when testing a touch screen.

### DETAILED DESCRIPTION

Several embodiments of the invention with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

Many electronic devices enable a user to interact with a graphical user interface through touch events, such as finger contacts and finger swipe gestures on a touch sensitive display (also known as a touch screen). Because users are capable of touching the touch screen with multiple fingers simultaneously to, for example, activate a pinching function, the touch screen (and perhaps its associated touch and gesture detection software) must be able to accurately track multiple fingers touching at the same time to support a multi-touch interface. It is desirable to test such a touch screen device, by simulating a user who interacts with the touch screen using multiple fingers. While the discussion below refers to a testing of a touch screen, the concepts being described here are also applicable to the testing of a “touch panel” which may or may not include a display screen on which a touch and a substantially transparent surface is overlaid.

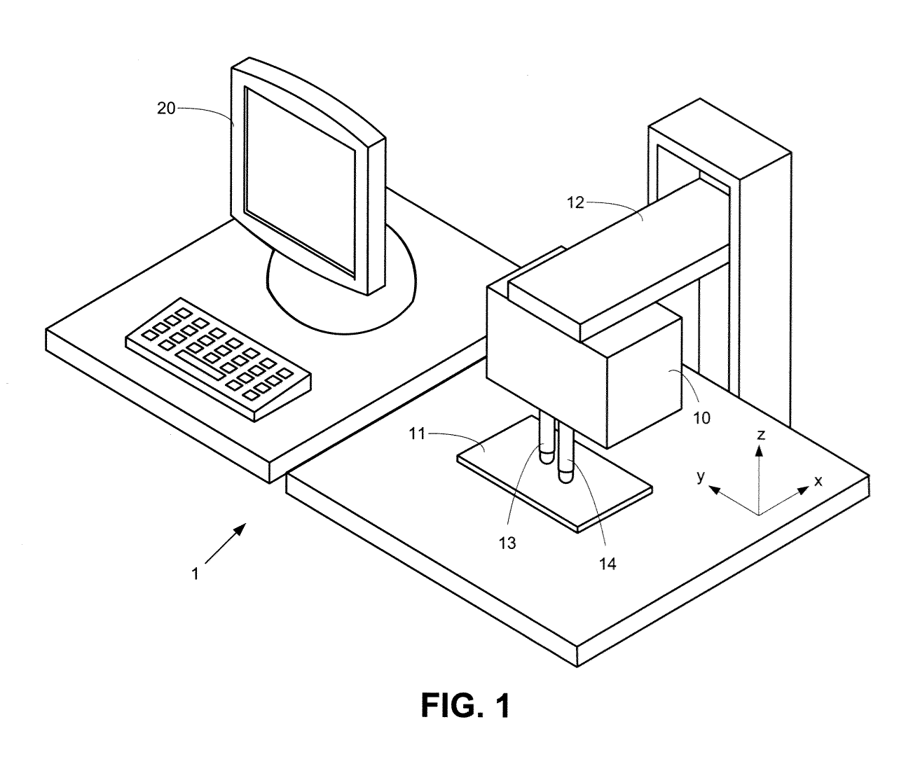

FIG. 1 shows an example of a touch screen testing system 1 with a robot hand 10 (also referred to here as a testing unit) and computer system 20 that may be used to test a touch sensitive panel 11 that supports a multi-touch interface. The touch sensitive panel 11 to be tested may be any touch sensitive input device, such as a multi-touch trackpad used in a laptop computer or a touch screen display used in a smartphone. The touch screen 11 may be a touch screen by itself, or it may be a touch screen that is already installed in an electronic device. The touch screen 11 may be of any type of sensing technology, such as capacitive sensing or resistive sensing, that simultaneously registers multiple distinct positions of input touches.

The robot hand 10 is coupled to a positioning arm 12. The positioning arm 12 is configured to move toward and away (e.g., in the z-direction) from the touch screen 11 to, for example, simulate a tap gesture. The positioning arm 12 may also be configured to move in a direction that is parallel (e.g., in the x or y-direction) to the touch screen 11 to, for example, simulate a swipe or a scroll gesture.

The robot hand 10 also includes testing fingers 13 and 14 (also referred to as testing members). The testing fingers 13 and 14 are coupled to the robot hand 10 so that they extend outwardly from the robot hand 10 in the same direction (e.g., in the z-direction). As shown in the embodiment of FIG. 1, the robot hand 10 may be a hexahedron shaped base member; in which case, the testing fingers 13 and 14 may be coupled to the same planar surface of the robot hand 10.

The testing finger 13 may be coupled to a motor (not shown) in the robot hand 10. The motor may be controlled to move the testing finger 13 toward or away from the testing finger 14 (e.g., in the y-direction) to, for example, simulate a pinch or an unpinch gesture. The testing finger 14 may be coupled to a motor to move the testing finger 14 toward or away from the testing finger 13 (e.g., in the y-direction). The motor coupled to testing finger 14 may be the same motor as the one coupled to testing finger 13, or it may be a separate motor.

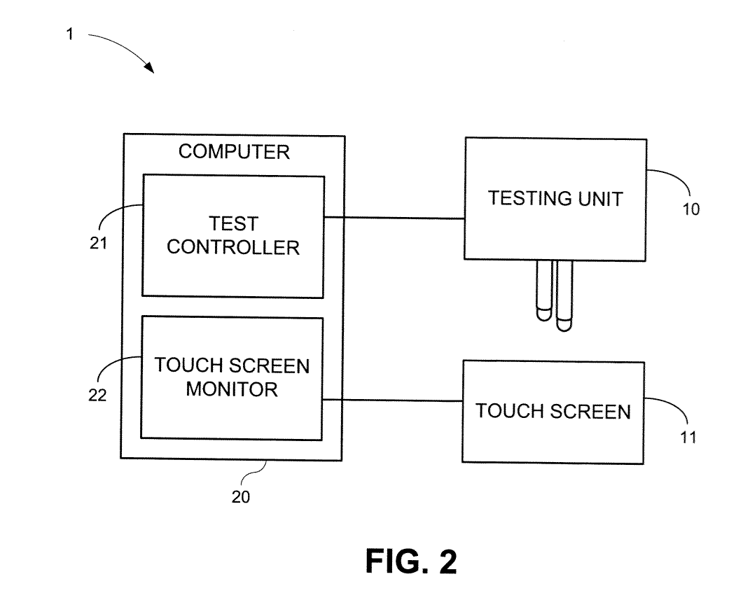

Referring to FIG. 2, the computer system 20 may include a test controller 21 and a touch screen monitor 22. The test controller 21 controls the movement of the positioning arm 12. The test controller 21 may send control signals to the positioning arm 12 to cause the robot hand 10 to move toward and away (e.g., in the z-direction in FIG. 1) from the touch screen 11. The control signals may also cause the positioning arm 12 to move in a direction parallel (e.g., in the x or y-direction in FIG. 1) to the touch screen 11. The test controller 21 may also send control signals to the robot hand 10 to control the motors in the robot hand 10. The motors then interpret the control signals to move the testing fingers 13 and 14, separately or simultaneously, toward or away from each other (e.g., in the y-direction in FIG. 1).

The computer system 20 may also include a touch screen monitor 22 that monitors the touch screen 11 to determine whether the touch screen 11 detected contact with the testing fingers. If the touch screen 11 is being tested by itself, the touch screen monitor 22 may be coupled to the touch screen 11. In the case where the touch screen 11 is a capacitive sensing touch screen, which registers a change in capacitance at a location where a finger touches the touch screen, the touch screen monitor 22 may measure the changes in capacitance of the touch screen 11, to detect a touch and to determine the location of the touch. In another embodiment, the touch screen monitor 22 may be coupled to an electronic device that has the touch screen 11 installed. In this case, the touch screen monitor 22 may communicate with a touch screen test application running in the device. When the touch screen 11 detects contact with a testing finger, the touch screen test application may send the touch screen monitor 22 a message indicating that the touch screen detected a touch. The message may also include the location of the touch.

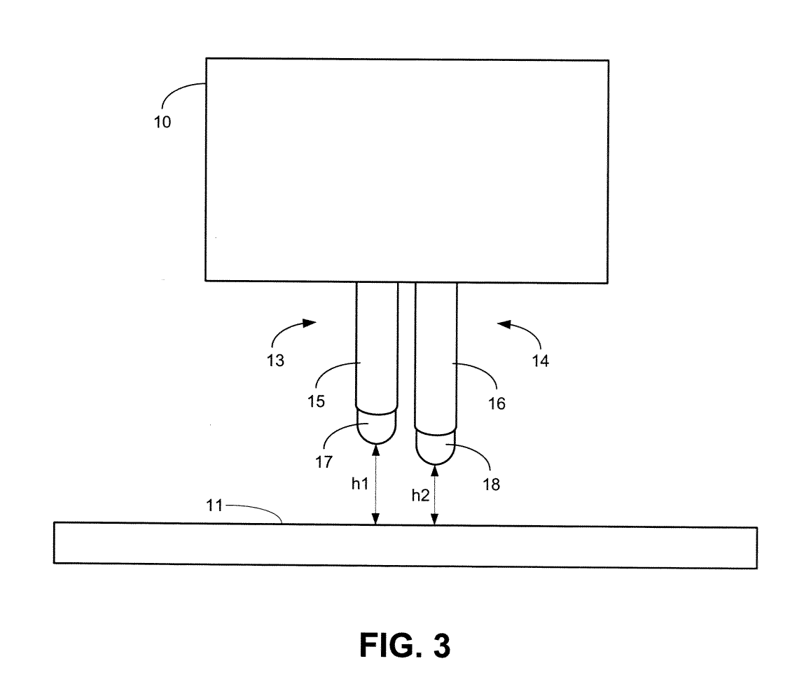

The robot hand 10 will now be described in more detail with reference to FIG. 3. As shown in FIG. 3, the testing fingers 13 and 14 may have two different lengths. For example, testing finger 13 may be shorter than the testing finger 14. In other words, the testing fingers 13 and 14 are configured so that they are at two different distances, h1 and h2, from the touch screen 11 when they are not touching the touch screen 11. The touch screen 11 in this embodiment is shown as being essentially horizontal. Alternatively, the touch screen 11 can be positioned at an angle.

When the positioning arm 12 moves the robot hand 10 toward the touch screen 11, the testing finger 14 touches the touch screen 11 first to induce a single touch event. A single touch event occurs when the touch screen registers contact with one testing finger. As the positioning arm 12 continues to move the robot hand 10 in the same direction toward the touch screen 11, the testing finger 14 compresses to allow the testing finger 13 to also touch the touch screen 11. This induces a multi-touch event, which occurs when the touch screen registers contact with multiple fingers.

The difference in the length between the testing finger 13 and the testing finger 14 is such that the testing finger 13 does not induce a multi-touch event when the testing finger 14 comes into contact with the touch screen 11. In other words, when the testing finger 14 comes into contact with the touch screen 11, the touch screen 11 should register contact with only one testing finger. In the case of a capacitive sensing touch screen, the difference in length between the testing finger 13 and the testing finger 14 is such that the testing finger 13 does not cause near field capacitive coupling with the touch screen 11 when the testing finger 14 comes into contact with the touch screen 11. The difference in length between the testing finger 13 and the testing finger 14 may be, for example, one-fourth of an inch.

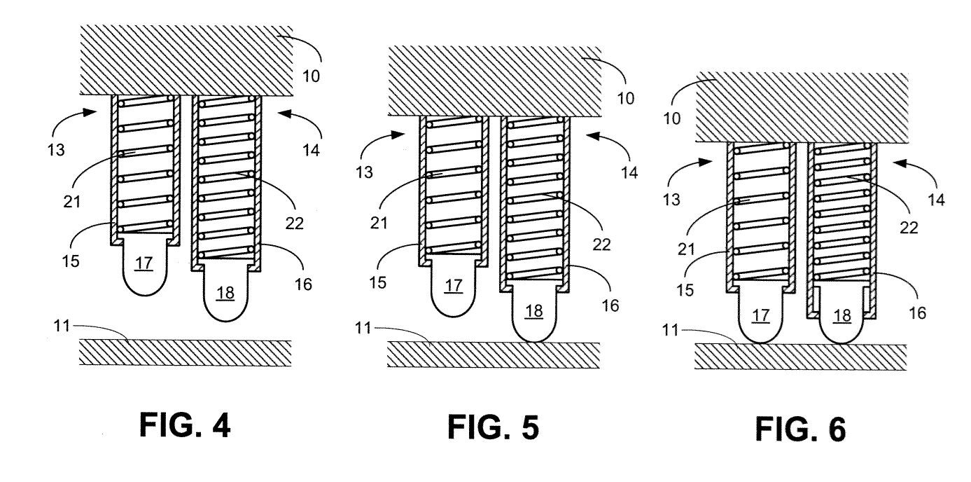

As shown in FIGS. 4-6, the testing finger 13 may include an elongated hollow extension 15 and a contact end 17. The contact end 17 may protrude out from an opening 19 at one end of the extension 15. The contact end 17 may be made of a conductive material, such as brass or other types of metal, which causes a change in capacitance of a capacitive touch screen panel at a location where the contact end 17 touches the touch screen 11. The testing finger 13 may include a cushioning mechanism, such as a compression spring 21. The compression spring 21 is positioned inside the extension 15 and extends across the length of the extension 15 to abut against the contact end 17. The compression spring 21 forces the contact end 17 to protrude out from the extension 15 and also allows the contact end 17 to retract into the extension 15 when the testing finger 13 touches the touch screen 11. Allowing the contact end 21 to retract into the extension 15 may reduce the probability of damaging the touch screen 11 when the testing finger 13 touches the touch screen 11.

Similarly, the testing finger 14 may include an elongated hollow extension 16 and a contact end 18. The contact end 18 may protrude out from an opening 20 at one end of the extension 16. The contact end 18 may be made of a conductive material. The testing finger 14 may include a compression mechanism, such as a compression spring 22. The compression spring 22 is positioned inside the extension 16 and extends across the length of the extension 16 to abut against the contact end 18. The compression spring 22 forces the contact end 18 to protrude out from the extension 16 and also allows the contact end 18 to retract into the extension 16. As the positioning arm 12 moves the robot hand 10 toward the touch screen 11 while the testing finger 14 is touching the touch screen 11, the robot hand 10 presses down on the testing finger 14. This forces the contact end 18 to retract into the extension 16. The testing finger 14 thus contracts to allow the testing finger 13 to also touch the touch screen 11. The operation of the robot hand 10 will now be described in more detail with reference to FIGS. 4-7.

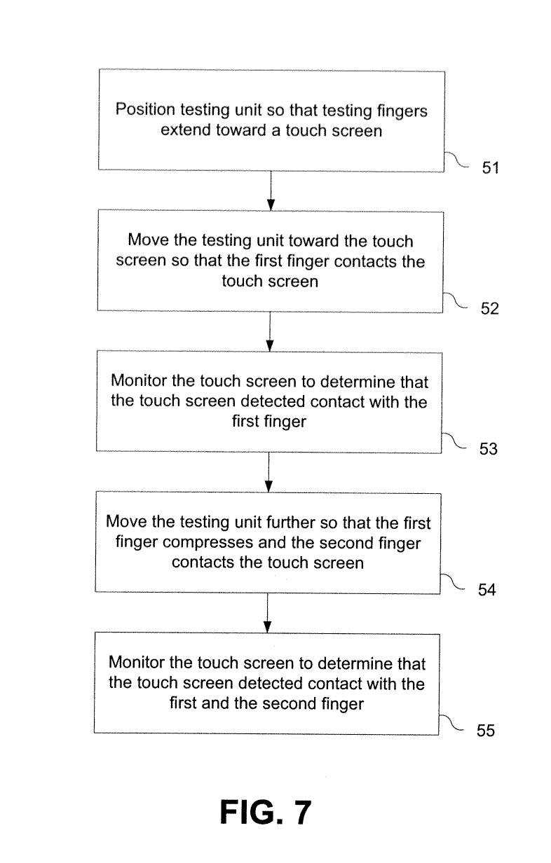

As shown in FIG. 4, the robot hand 10 is positioned so that the testing fingers 13 and 14 extend toward the touch screen 11 (in block 51 of FIG. 7). For example, in the embodiment of FIGS. 4-6, the robot hand 10 may be positioned over the touch screen 11 with the testing fingers 13 and 14 pointing down toward the touch screen 11. The test controller 21 then signals the positioning arm 12 to move the robot hand 10 toward the touch screen 11. As the robot hand 10 moves closer to the touch screen 11, the testing finger 14 touches the touch screen 11 (in FIG. 5 and block 52 of FIG. 7). Meanwhile, the touch screen monitor 22 monitors the touch screen 11 to determine whether the touch screen 11 detects contact with the testing finger 14 (i.e., whether the touch screen 11 registers a single touch event) (in block 53 of FIG. 7).

The positioning arm 12 continues to move the robot hand 10 in the same direction toward the touch screen 11 after the testing finger 14 touches the touch screen 11. The force of the robot hand 10 pressing down on the testing finger 14 while the testing finger 14 is in contact with the touch screen 11 causes the contact end 18 to press against the spring 22 and compress the spring 22. The contact end 18 thus retracts into the extension 16, and the testing finger 14 contracts. This allows the testing finger 13 to also contact the touch screen 11 (in FIG. 6 and block 54 of FIG. 7). Meanwhile, the touch screen monitor 22 monitors the touch screen 11 to determine whether the touch screen 11 detects successive contacts with the testing finger 13 and the testing finger 14 (i.e., whether the touch screen 11 registers a multi-touch event) (in block 55 of FIG. 7). The test controller 21 may then signal the positioning arm 12 to stop moving the robot hand 10 toward the touch screen 11. The test controller 21 may also signal the positioning arm 12 to stop moving the robot hand 10 toward the touch screen 11 after the positioning arm 12 has moved a preset distance, to avoid damaging the touch screen in the case where the touch screen does not register successive contacts with testing fingers 13 and 14.

While testing fingers 13 and 14 are both in contact with the touch screen 11, the test controller 21 may signal the robot hand 10 to move the testing fingers 13 and 14 away from each other. The touch screen monitor 22 may monitor the touch screen 11 to determine whether the touch screen 11 detects changes in the locations of contact with the testing fingers 13 and 14 that are representative of an unpinching gesture. The test controller 21 may signal the robot hand 10 to move the testing fingers 13 and 14 toward each other. The touch screen monitor 22 may monitor the touch screen 11 to determine whether the touch screen 11 detects changes in the locations of contact with the testing fingers 13 and 14 that are representative of a pinching gesture.

While one or both testing fingers are in contact with the touch screen 11, the test controller 21 may signal the positioning arm 12 to move the robot hand 10 in a direction that is parallel to the touch screen 11. The touch screen monitor 22 may monitor the touch screen 11 to determine whether the touch screen 11 detects changes in the locations of contact with one or both testing fingers that are representative of a swipe or a scroll gesture.

For purposes of explanation, specific embodiments of the invention have been described to provide a thorough understanding of the present invention. These should not be construed as limiting the scope of the invention but merely as illustrating different examples and aspects of the invention. It should be appreciated that the scope of the invention includes other embodiments not discussed in detail above. Various other modifications, changes, and variations which will be apparent to those skilled in the art may be made in the arrangement, operation, and details of the systems and methods of the present invention disclosed herein without departing from the spirit and scope of the invention as defined in the appended claims. For instance, while the figures show the compression mechanisms in the testing fingers 13 and 14 as being compression springs 21 and 22, an alternative is to replace the compression springs with compressible foam. Therefore, the scope of the invention should be determined by the claims and their legal equivalents. Such equivalents include both currently known equivalents as well as equivalents developed in the future, i.e., any elements developed that perform the same function, regardless of structure. Furthermore, no element, component, or method step is intended to be dedicated to the public regardless of whether the element, component, or method step is explicitly recited in the claims.

What is claimed is:

1. An apparatus for testing a touch panel, comprising:
a robot hand that moves relatively toward and away from the touch panel;
a first testing finger coupled to the robot hand; and
a second testing finger coupled to the robot hand,
wherein the first testing finger is to contact the touch panel to cause a single touch event, and the second testing finger is to subsequently contact the touch panel to cause a multi-touch event, as the robot hand moves toward the touch panel.

2. The apparatus of claim 1, wherein the robot hand includes a planar surface, and the first testing finger and the second testing finger are coupled to the planar surface.

3. The apparatus of claim 1, wherein the first testing finger has a length that is greater than the second testing finger.

4. The apparatus of claim 3, wherein a difference in the length between the first testing finger and the second testing finger is such that the second testing finger does not induce the multi-touch event when the first testing finger comes into contact with the touch panel.

5. The apparatus of claim 1, wherein the first testing finger includes a compression mechanism to allow the first testing finger to compress in response to the force of the robot hand moving toward the touch panel so that the second testing finger can touch the touch panel while the first testing finger remains in contact with the touch panel.

6. The apparatus of claim 1, wherein the second testing finger includes a cushioning mechanism to reduce the probability of damaging the touch panel when the second finger touches the touch panel.

7. The apparatus of claim 1, wherein the robot hand is configured to move in a direction that is parallel to the touch panel.

8. The apparatus of claim 1, wherein the first testing finger is configured to move toward and away from the second testing finger.

9. The apparatus of claim 1, wherein the first testing finger and the second testing finger have a surface for contacting the touch panel that is made of a conductive material.

10. A system for testing a touch panel, comprising:
a robot hand having at least two testing fingers of different lengths, wherein the testing fingers are to contact the touch panel successively as the robot hand moves toward the touch panel;
test controller circuitry to control the robot hand so as to cause the robot hand to move toward and away from the touch panel; and
touch screen monitoring circuitry to monitor the touch panel to determine that the touch panel detected successive taps as a result of the testing fingers successively touching the touch panel.

11. The system of claim 10, wherein the test controller circuitry controls the robot hand so as to cause one testing finger to move toward and away from the other testing finger.

12. The system of claim 11, wherein the touch screen monitoring circuitry is to monitor the touch panel to determine that the touch panel detected changes in contact that are representative of a pinch event, as a result of one testing finger moving toward the other testing finger while both testing fingers are touching the touch panel.

13. The system of claim 11, wherein the touch screen monitoring circuitry is to monitor the touch panel to determine that the touch panel detected changes in contact that are representative of an unpinch event, as a result of one testing finger moving away from the other testing finger while both testing fingers are touching the touch panel.

14. The system of claim 10, wherein the test controller circuitry controls the robot hand so as to cause the robot hand to move in a direction that is parallel to the touch panel.

15. The system of claim 14, wherein the touch screen monitoring circuitry is to monitor the touch panel to determine that the touch panel detected changes in contact that are representative of a swipe event, as a result of one testing finger moving across the touch panel while the one testing finger is touching the touch panel.

16. The system of claim 10, wherein each testing finger has a contact end that causes a change in capacitance of the touch panel at a location where the contact end touches the touch panel.

17. The system of claim 16, wherein one testing finger has a compression spring to allow the contact end of the one testing finger to retract into the one testing finger in response to the force of the robot hand moving toward the touch panel, so that the other testing finger can touch the touch panel while the one testing finger remains in contact with the touch panel.

18. The system of claim 17, wherein the difference in length between the testing fingers is such that the contact end of the other testing finger does not cause the change in capacitance when the contact end of the one testing finger comes into contact with the touch panel.

19. A method for testing a multi-touch touch panel, comprising:
positioning a base that is coupled to a first testing element and a second testing element such that the first and second testing elements extend toward the touch panel;
moving the base toward the touch panel so that the first testing element contacts the touch panel;
monitoring the touch panel to determine that the touch panel detected contact with the first testing element;
moving the base further in the same direction toward the touch panel so as to cause the first testing element to compress and the second testing element to contact the touch panel; and
monitoring the touch panel to determine that the touch panel detected contact with the first and the second testing elements.

20. The method of claim 19, further comprising:
moving the first testing element toward the second testing element while the first and the second testing elements are in contact with the touch panel; and
monitoring the touch panel to determine that the touch panel detected changes in contact that are representative of a pinching gesture.

21. The method of claim 19, further comprising:
moving the first testing element away from the second testing element while the first and the second testing elements are in contact with the touch panel; and
monitoring the touch panel to determine that the touch panel detected changes in contact that are representative of an unpinching gesture.

22. The method of claim 19, further comprising:
moving the base in a direction parallel to the touch panel; and
monitoring the touch panel to determine that the touch panel detected changes in contact that are representative of a swiping gesture.
